(19) United States
(12) Patent Application Publication
(10) Pub. No.: US 2026/0298680 A1
(43) Pub. Date: Oct. 1, 2026

(54) METHOD FOR OPERATING AN ULTRASONIC FLOWMETER AND ULTRASONIC FLOWMETER

(71) Applicant: KROHNE AG, Basel (CH)

(72) Inventors: Arie HUIJZER, Sliedrecht (NL); Jeroen VAN KLOOSTER, Tiel (NL)

(73) Assignee: KROHNE AG, Basel (CH)

(21) Appl. No.: 19/630,625

(22) Filed: Mar. 27, 2026

(30) Foreign Application Priority Data
Mar. 28, 2025 (DE) 10 2025 112 218.0

(51) Int. Cl. G01F 1/66; G01F 1/667

(52) U.S. Cl. CPC G01F 1/662; G01F 1/668

(57) ABSTRACT

An ultrasonic flowmeter and a method of operating the ultrasonic flowmeter, wherein the ultrasonic flowmeter comprises at least one pair of ultrasonic transducers comprising a first ultrasonic transducer and a second ultrasonic transducer, at least one third ultrasonic transducer, at least one ultrasonic transducer holder arrangement and a control and evaluation unit. The ultrasonic transducer holder arrangement has at least one ultrasonic transducer holder that is arranged on a measuring tube that has a measuring tube wall. A medium is present in the measuring tube that flows through the measuring tube. The first and second ultrasonic transducers are arranged on the ultrasonic transducer holder arrangement. The first ultrasonic transducer and the second ultrasonic transducer are arranged offset from one another as viewed in the direction of flow of the medium in such a way that they span between them a measuring path that passes through the ultrasonic transducer holder arrangement.

This nonprovisional application claims priority under 35 U.S.C. § 119 (a) to German Patent Application No. 10 2025 112 218.0, which was filed in Germany on Mar. 28, 2025, and which is herein incorporated by reference.

### BACKGROUND OF THE INVENTION

### Field of the Invention

The invention relates to a method for operating an ultrasonic flowmeter, wherein the ultrasonic flowmeter has at least one ultrasonic transducer pair with a first ultrasonic transducer and a second ultrasonic transducer, at least one third ultrasonic transducer, at least one ultrasonic transducer holding arrangement, and a control and evaluation unit, wherein the ultrasonic transducer holding arrangement comprises at least one ultrasonic transducer holder, wherein the ultrasonic transducer holding arrangement is arranged on a measuring tube, wherein the measuring tube has a measuring tube wall, wherein a medium is present in the measuring tube, in particular, the medium flows through the measuring tube, wherein the first and second ultrasonic transducers are arranged on the ultrasonic transducer holder arrangement, wherein the first ultrasonic transducer and the second ultrasonic transducer are arranged offset from each other in the direction of flow of the medium in such a way that they span a measuring path between them, which runs through the ultrasonic transducer holder arrangement, the measuring tube wall and the medium, so that a measuring signal emitted by the first ultrasonic transducer is received by the second ultrasonic transducer and vice versa, wherein the measuring signal passes through three materials, namely the ultrasonic transducer holder arrangement, the measuring tube wall and the medium, and wherein the third ultrasonic transducer is arranged on the ultrasonic transducer holder arrangement in such a way that it defines at least a first reference path running through the ultrasonic transducer holder arrangement, the measuring tube wall, and the medium, wherein the third ultrasonic transducer is designed and arranged in such a way that it receives a reference signal propagating along the first reference path and optionally also emits a reference signal propagating along the first reference path, wherein the control and evaluation unit is designed to control the ultrasonic transducers and to evaluate the signals received by the ultrasonic transducers.

Furthermore, the invention relates to an ultrasonic flowmeter comprising at least one ultrasonic transducer pair with a first ultrasonic transducer and a second ultrasonic transducer, at least one third ultrasonic transducer, at least one ultrasonic transducer holding arrangement, wherein the ultrasonic transducer holding arrangement comprises at least one ultrasonic transducer holder, wherein the at least one ultrasonic transducer holding arrangement is arranged on a measuring tube during operation, wherein the measuring tube has a measuring tube wall, wherein a medium is arranged in the measuring tube during operation, in particular, wherein, during operation, a medium flows through the measuring tube, wherein the first and second ultrasonic transducers are arranged on the ultrasonic transducer holding arrangement, wherein the first ultrasonic transducer and the second ultrasonic transducer are arranged offset from each other in the direction of flow of the medium in such a way that they span a measuring path between them, which runs through the ultrasonic transducer holding arrangement, the measuring tube wall and the medium, so that a measuring signal emitted by the first ultrasonic transducer is received by the second ultrasonic transducer and vice versa, wherein the measuring signal passes through three materials, namely the ultrasonic transducer holding arrangement, the measuring tube wall and the medium, and wherein the third ultrasonic transducer is arranged on the ultrasonic transducer holder arrangement in such a way that it defines at least a first reference path running through the ultrasonic transducer holder arrangement, the measuring tube wall and the medium, wherein the third ultrasonic transducer is designed and arranged in such a way that it receives a reference signal propagating along the first reference path and optionally also emits a reference signal propagating along the first reference path, wherein the control and evaluation unit is designed to control the ultrasonic transducers and to evaluate the signals received by the ultrasonic transducers.

### Description of the Background Art

To determine the flow velocity of a medium flowing through a measuring tube with an ultrasonic flowmeter, the transit time of a measuring signal propagating between two ultrasonic transducers in the direction of flow and the transit time of a measuring signal propagating in the opposite direction to the flow are captured, and the flow velocity is determined from the difference in transit time.

Particularly relevant for this calculation is the part of the transit time during which the measuring signal emitted by an ultrasonic transducer travels through the medium, as this part carries the information about the flow velocity of the medium. From the total duration of a measuring signal emitted by a first ultrasonic transducer and captured by a second ultrasonic transducer, the delay time ta during which the measuring signal travels through an ultrasonic transducer mounting arrangement—provided the ultrasonic transducer is arranged on such an arrangement—and/or through the measurement tube wall must therefore be subtracted.

In ultrasonic flow meters known from the prior art, this delay time ta is often included as a constant in the calculation of the velocity of the medium. In fact, the delay time ta is not constant due to fluctuating process conditions. Fluctuations in the sound velocities of the ultrasonic transducer holder arrangement and/or the measuring tube wall and/or the medium, which can be attributed to temperature changes, for example, result in a change in the course of the measuring path. Due to Snell's law of refraction, the angle of incidence of a measuring signal entering the second medium from the first medium changes at the transition between the two media according to:

$$\frac{sin ( {β}_{1} )}{{c}_{1}} = \frac{sin ( {β}_{2} )}{{c}_{2}}$$

wherein β₁ is the angle of incidence to the perpendicular to the interface in the first medium, wherein c₁ is the sound velocity in the first medium, wherein β₂ is the angle of refraction to the perpendicular to the interface in the second medium, and wherein c₂ is the sound velocity of the second medium.

A change in the course of the measurement path within the ultrasonic transducer holder arrangement and/or the measuring tube wall also changes the delay time ta, which results in a measurement error in the evaluation of the total transit time and thus in the determination of the flow velocity if this is not taken into account.

The flow velocity of a flowing medium is determined according to the following relationship:

$$v = \frac{{L}_{3}}{2 \cdot cos ( θ )} \cdot \frac{{t}_{up} - {t}_{down}}{( {t}_{up} - {t}_{d} ) \cdot ( {t}_{down} - {t}_{d} )}$$

wherein L₃ corresponds to the measurement path section in the medium, wherein θ is the measurement angle of the measuring signal in the medium, wherein tup corresponds to the transit time of a measuring signal propagating along the measurement path against the direction of flow, wherein t_{down} corresponds to the transit time of a measuring signal propagating in the direction of flow along the measurement path, and wherein ta corresponds to the delay time, i.e., the time in which the measuring signal propagates through the ultrasonic transducer holder arrangement and/or through the measuring tube wall.

It is known from publication WO 2023/274557 A that, in order to determine the flow rate of a flowing medium using a clamp-on ultrasonic flowmeter, the temperature dependence of the sound velocity in the area between the ultrasonic transducers and the measuring tube or the medium must be taken into account. For this purpose, the measuring device has six ultrasonic transducers which are arranged on the ultrasonic transducer holder surrounding the measuring tube in such a way that two pairs of ultrasonic transducers are arranged for emitting and receiving a measuring signal that passes diagonally through the measuring tube, and that a third pair of ultrasonic transducers is arranged in such a way that a measuring signal is emitted into the measuring tube perpendicular to the direction of flow and is captured by the diametrically opposite transducer. The sound velocity of the ultrasonic transducer holder or the medium, as well as all design parameters such as the measuring tube wall thickness, are determined by reflection at the interface between the ultrasonic transducer holder and the measuring tube or between the fluid and the measuring tube. However, this can be problematic if the reflection is weak or cannot be measured at all due to only slight differences in the impedance of the materials.

### SUMMARY OF THE INVENTION

It is therefore an object of the present invention to provide a method for operating an ultrasonic flowmeter that can guarantee a particularly low measurement error for many applications. In addition, the invention aims to provide an ultrasonic flowmeter for performing the method according to the invention.

According to a first teaching of the present invention, the object described above is achieved by a method for operating an ultrasonic flowmeter described at the beginning, in that the method comprises the following steps:
Emitting the measuring signal by the first ultrasonic transducer or the second ultrasonic transducer, wherein the measuring signal propagates along the measurement path,
Receiving the measuring signal by the second ultrasonic transducer or the first ultrasonic transducer and determining the total transit time tₜₒₜₐₗ, wherein tₜₒₜₐₗ corresponds to the total transit time of the measuring signal between the first ultrasonic transducer and the second ultrasonic transducer,
Emitting the first reference signal by the third or a further ultrasonic transducer,
Receiving the first reference signal by the third ultrasonic transducer and determining the reference transit time t_{ref}, wherein t_{ref} corresponds to the transit time of the first reference signal between the ultrasonic transducer emitting the first reference signal and the third ultrasonic transducer,
Determining the velocity v of the flowing medium using known design parameters of the measuring arrangement, the measured transit times t_{ref} and tₜₒₜₐₗ, and the sound velocity c₁ of the ultrasonic transducer holder arrangement.

According to the invention, it was recognized that determining the velocity v of the flowing medium is particularly accurate if, in addition to measuring the total transit time tₜₒₜₐₗ of a measuring signal propagating along the measurement path, at least one further reference transit time t_{ref} of a reference signal propagating through the ultrasonic transducer holder arrangement, the measuring tube wall, and the medium is captured. This means that two current measured values describing the current state of the measuring arrangement are taken into account when determining the flow velocity.

Using the aforementioned input variables to be taken into account, specifically the known design parameters of the measuring arrangement and the sound velocity c₁ of the ultrasonic transducer holder arrangement and the measured transit times, the propagation of the measuring signal, in particular the current course of the measuring path and, in this respect, the delay time ta of the measuring signal, can be determined with particular accuracy.

Taking into account the measured transit times and other known design parameters of the measuring arrangement, it is possible to determine, in particular, the current course of the measuring path in the ultrasonic transducer holder arrangement, the measuring tube wall, and the medium.

The course of the measuring path is understood to be the geometric description of the measuring path. Determining the course of the measuring path includes at least determining the length of the individual measuring path sections through the different materials. In particular, determining the course also includes determining the measuring angle θ, which is relevant in determining the flow velocity of the flowing medium.

The delay time ta required for the measuring signal to pass through the ultrasonic transducer holder arrangement and the measuring tube wall can be determined from the course of the measuring path. This current delay time can be advantageously taken into account when determining the flow velocity, so that the determination of the transit times through the medium of the measuring signals emitted in and against the direction of flow is particularly accurate.

This method is particularly advantageous when the delay time ta is of the order of magnitude of the transit time of the measuring signal through the medium. Particularly in the case of small dimensions, it is also possible that the delay time ta is greater than the transit time of the measuring signal through the medium. In these arrangements, the error in determining the transit time through the medium and, in this respect, in determining the flow velocity can very quickly become very large.

In addition, the method according to the invention can be used both in measuring arrangements in which the acoustic impedance of the measuring tube differs greatly from the acoustic impedance of the medium, so that sufficiently strong reflections can be ensured, and in measuring arrangements in which the acoustic impedance of the measuring tube has a similar value to the acoustic impedance of the medium. A significant difference in impedance exists, for example, when the measuring tube is made of metal, while only a slight difference in impedance exists when the measuring tube is made of plastic, for example.

In measuring arrangements according to the invention, the measuring signal, as well as the first reference signal, passes through three materials, namely the ultrasonic transducer holder arrangement, the measuring tube wall, and the medium.

According to one design of the method, a parameter is defined for each material that determines the course of the measurement path in that material. According to this design, the method for determining the velocity v of the flowing medium comprises the following steps:
Determining three unknown parameters using the known design parameters of the measuring arrangement, the measured transit times t_{ref} and tₜₒₜₐₗ, and the sound velocity c₁ of the ultrasonic transducer holder arrangement, wherein each unknown parameter determines the course of the measuring path in one of the three materials, in particular where the unknown parameters are geometric parameters, preferably lengths or angles,
Determining the course of the measurement path in the ultrasonic transducer holder arrangement, in the measuring tube wall and in the medium, and determining the delay time ta of the measuring signal, wherein the delay time ta corresponds to the transit time of the measuring signal through the ultrasonic transducer holder arrangement and through the measuring tube wall, and
Determining of the velocity v of the flowing medium, taking into account the current delay time t_{d}.

According to an advantageous design, the velocity v of the flowing medium is determined using trained artificial intelligence, in particular a trained artificial neural network, wherein the artificial intelligence determines as input variables the design parameters, the measured transit times t_{ref} and tₜₒₜₐₗ, and the sound velocity c₁ of the ultrasonic transducer holder arrangement, and wherein the artificial intelligence provides as an output variable at least the velocity v of the flowing medium. For this purpose, the control and evaluation unit has artificial intelligence.

The artificial intelligence can be trained particularly advantageously with data obtained or simulated using one of the methods described below.

In particular, the artificial intelligence implicitly or explicitly determines a parameter from the input variables that correlates with the current delay time ta or corresponds to the delay time ta. Optionally, the artificial intelligence can output the current delay time ta and/or the total path length L of the measuring path and/or the path length L₁ through the ultrasonic transducer holder arrangement and/or the path length L₂ through the measuring tube wall and/or the path length L₃ through the medium.

According to a further design, the method for determining the unknown parameters comprises the following steps:
Creation of a system of equations with three equations,
wherein the first equation describes a relationship between the total transit time tₜₒₜₐₗ of the measuring signal and the individual transit times of the measuring signal via the measurement path through the ultrasonic transducer holder arrangement, the measuring tube wall, and the medium, taking into account the design parameters, wherein the second equation describes a relationship between the reference transit time t_{ref} and the individual transit times of the reference signal over the reference path through the ultrasonic transducer holder arrangement, the measuring tube wall, and the medium, taking into account the design parameters, and wherein the third equation describes a geometric relationship between the distance between the first ultrasonic transducer and the second ultrasonic transducer and three geometric parameters, wherein one geometric parameter describes the course of the measurement path in the ultrasonic transducer holder arrangement, wherein one geometric parameter describes the course of the measurement path in the measuring tube wall, and wherein one geometric parameter describes the course of the measurement path in the medium, wherein the system of equations contains at most three unknown parameters, wherein each unknown parameter determines the course of the measuring path in one of the three materials, in particular wherein the unknown parameters are geometric parameters, preferably lengths or angles,
solving the system of equations and determining the unknown parameters.

According to one design, the geometric parameters of the third equation are the unknown parameters to be determined.

According to one design, the first ultrasonic transducer and the second ultrasonic transducer are arranged at a distance 2A from each other. According to this design, the third equation describes the relationship between the half distance A between the first and second ultrasonic transducers and the three parameters A₁, A₂, and A₃, wherein A₁ corresponds to the portion of the measuring path in the ultrasonic transducer holding arrangement in the direction of connection, i.e., in the axial direction relative to the longitudinal axis of the measuring tube, of the first ultrasonic transducer and the second ultrasonic transducer, wherein A₂ corresponds to the proportion of the measuring path in the measuring tube wall in the direction of connection of the first ultrasonic transducer and the second ultrasonic transducer, and wherein As corresponds to the proportion of the measuring path in the medium in the direction of connection of the first ultrasonic transducer and the second ultrasonic transducer.

It is particularly preferred that the measuring path is designed to be symmetrical. The half distance A between the first and second ultrasonic transducers in the axial direction of the measuring tube defines the symmetry point. The description of the measuring path before the symmetry point corresponds to the description of the measuring path behind the symmetry point in the direction of connection between the first and second ultrasonic transducers. In this respect, when determining the path lengths L₁ through the ultrasonic transducer holder arrangement, L₂ through the measuring tube wall, and L₃ through the medium, as defined below, the path described before the symmetry point can be doubled. The lengths A₁, A₂, and A₃ determine the path length of a single passage of the measuring signal through a material.

If the distance between the ultrasonic transducers is 2A, the measuring signal passes through all three materials up to a distance A. Depending on the exact measurement arrangement, specifically the shape of the measurement path, the measuring signal passes through each material at least once in the A range.

If the measuring signal passes through each material exactly once, the third equation applies:

$$A = {A}_{1} + {A}_{2} + {A}_{3}$$

wherein A₁ corresponds to the proportion of the measuring path in the ultrasonic transducer holding arrangement in the direction of connection, i.e., in the axial direction relative to the longitudinal axis of the measuring tube, of the first ultrasonic transducer and the second ultrasonic transducer,
wherein A₂ corresponds to the proportion of the measuring path in the measuring tube wall in the direction of connection of the first ultrasonic transducer and the second ultrasonic transducer, and
wherein A₃ corresponds to the proportion of the measuring path in the medium in the direction of connection of the first ultrasonic transducer and the second ultrasonic transducer.

If, for example, the measuring path is V-shaped and the measuring signal is reflected at the outer measuring tube wall after passing through the medium, the measuring signal passes through the measuring tube wall twice in region A. Then the following applies:

$$A = {A}_{1} + 2 \cdot {A}_{2} + {A}_{3}$$

wherein A₁ corresponds to the proportion of the measuring path in the ultrasonic transducer holding arrangement in the direction of connection, i.e., in the axial direction relative to the longitudinal axis of the measuring tube, of the first ultrasonic transducer and the second ultrasonic transducer,
wherein A₂ corresponds to the proportion of the measuring path in the measuring tube wall in the direction of connection of the first ultrasonic transducer and the second ultrasonic transducer, and
wherein A₃ corresponds to the proportion of the measuring path in the medium in the direction of connection of the first ultrasonic transducer and the second ultrasonic transducer.

According to one design, the parameters A₁, A₂, and A₃ correspond to the unknown variables of the system of equations.

Alternatively, the unknown parameters may also be angles that define the course of the measuring path sections.

According to a particularly advantageous design, the first equation and/or the second equation of the system of equations take into account as design parameters the distance B₁ of the radiating element of the first ultrasonic transducer to the measuring tube and/or the distance B₂ of the second ultrasonic transducer to the measuring tube and/or the distance B₃ of the radiating element of the third ultrasonic transducer to the measuring tube and/or the thickness T of the measuring tube wall and/or the inner radius R of the measuring tube.

According to one design of the method, the design parameters are known, for example, from specifications of the measuring device. According to a further design of the method, the thickness T of the measuring tube wall and/or the inner radius R of the measuring tube is measured by measuring the transit time of a reflection of the first reference signal.

In principle, the distance B₁ between the radiating element of the first ultrasonic transducer and the measuring tube, the distance B₂ between the second ultrasonic transducer and the measuring tube, and the distance B₃ between the radiating element of the third ultrasonic transducer and the measuring tube can be equal. Alternatively, the values of B₁, B₂, and B₃ can also differ at least partially.

According to a preferred design, the measuring path L can be divided into measuring path sections L₁, L₂, and L₃, wherein the measuring path section L₁ runs in the ultrasonic transducer holding arrangement, wherein the measuring path section L₂ runs in the measuring tube wall, and wherein the measuring path section L₃ runs in the medium. Each measuring path section L₁, L₂, L₃ preferably comprises at least one hypotenuse of a right-angled triangle. Successive measuring path sections made of different materials are connected to each other via Snell's law of refraction.

The sum of the measuring path sections traversed by the measuring signal corresponds to the total path length L of the measuring path.

The following therefore applies:

$$L = {L}_{1} + {L}_{2} + {L}_{3} .$$

According to a further preferred design, the first reference path passes perpendicularly to the direction of flow of the medium through the ultrasonic transducer holder arrangement, the measuring tube wall, and the medium, so that no refraction occurs at the material transitions. This design has the advantage that no further unknown geometric parameters are added when setting up the system of equations, in particular the second equation. Rather, relationships characterizing the material transition can be used for both the first equation and the second equation to reduce the total number of unknown parameters in the system of equations.

In particular, in the first equation, the transit times of the measuring signal along the measurement path through the measurement tube wall and through the medium are expressed as a function of the sound velocity c₁ of the ultrasonic transducer holder arrangement, and/or in the second equation, the propagation times of the measuring signal along the measurement path through the measurement tube wall and through the medium are expressed in dependence on the sound velocity c₁ of the ultrasonic transducer holder arrangement.

The sound velocity c₁ can be considered to be given and constant. Alternatively, the sound velocity can also be measured via a second reference path, as described below.

According to a further advantageous design, the solution of the system of equations provides the total path length L of the measuring path and/the length of the individual measuring path sections L₁, L₂, and L₃ and/or the refraction angle β₂ of the measuring signal at the transition into the measuring tube wall and/or the refraction angle β₃ of the measuring signal at the transition into the medium and/or the sound velocity c₂ of the measuring tube wall and/or the sound velocity c₃ of the medium are determined.

According to a further design, a second reference path is provided, wherein the second reference path runs only within the material of the ultrasonic transducer holder arrangement, and wherein the sound velocity c₁ of the ultrasonic transducer holder arrangement is determined by measuring the transit time of a second reference signal propagating along the second reference path.

For example, the second reference path may run in the ultrasonic transducer holding arrangement. Alternatively, an attachment may be provided in which the second reference path is implemented. It is relevant here that the attachment is made of the material of the ultrasonic transducer holding arrangement.

It is particularly preferred that the system of equations is solved numerically, taking into account boundary conditions of the unknown parameters to be determined. The equation system set up is, in particular, a nonlinear equation system that can have several solutions.

If the unknown parameters are the geometric parameters A₁, A₂, and A₃ or angles, there may be a range of values that is useful or possible for the measuring arrangement. Values that are not achievable are not considered possible solutions to the equation system.

According to a preferred design, the radiating elements of the ultrasonic transducers are piezo elements. The piezo elements are preferably dimensioned such that the opening angle of the emitted signal is dimensioned such that as much energy as possible propagates along the measurement path or the reference path. In principle, within the scope of the present invention, in particular when setting up and solving the system of equations, the measuring signal and the first reference signal and, if available, the second reference signal are regarded as a single path. This assumption is justified because this consideration reduces the measuring signal to the shortest path with the shortest transit time.

If the radiating elements of the ultrasonic transducers are arranged on an inclined surface of the ultrasonic transducer holder arrangement, then, provided that c₁<c₂ is satisfied, the angle of the measuring signal to the perpendicular to the measurement tube wall and thus the angle β₁ at which the measuring signal strikes the measurement tube wall is smaller than the critical angle at which, according to Snell's law of refraction, there is no longer any transmission. This condition also limits the opening angle of the measuring signal. Preferably, the opening angle is dimensioned such that as much energy as possible from the measurement signal propagates along the measurement path. The restriction of the opening angle of the measurement signal also limits the possible values for A₁ and A₂.

The method according to the invention has the advantage that, by taking into account the effect of varying process conditions, in particular varying sound velocities of the medium and/or the measuring tube wall and the ultrasonic transducer holder arrangement on the course of the measuring path and, in this respect, on the delay time, offset errors in the determination of the flow velocity can be virtually eliminated.

According to a second teaching of the present invention, the object mentioned at the outset is achieved by an ultrasonic flowmeter described at the outset in that the control and evaluation unit is designed to perform one of the methods described above.

With regard to the design of the ultrasonic flowmeter, reference is made to all previous and subsequent descriptions.

According to a particularly preferred design, the third ultrasonic transducer is arranged on the ultrasonic transducer holder arrangement in such a way that the first reference path runs perpendicular to the direction of flow of the flowing medium. It is particularly preferred that the piezo element of the third ultrasonic transducer is aligned perpendicular to the direction of flow and arranged on the ultrasonic transducer holder arrangement.

According to a design, the third ultrasonic transducer can both emit the first reference signal and receive the reflected reference signal. According to a further design, a fourth ultrasonic transducer is provided. According to this design, the first reference path runs between the third ultrasonic transducer and the fourth ultrasonic transducer. The third ultrasonic transducer can emit the first reference signal, wherein the fourth ultrasonic transducer receives the first reference signal and vice versa.

According to a further preferred design, the ultrasonic transducers are arranged in such a way that a second reference path, via which a second reference signal propagates, is present, wherein the second reference path runs only within the material of the ultrasonic transducer holding arrangement. For example, the second reference path is designed to run between the first ultrasonic transducer and the third ultrasonic transducer. Alternatively, the second reference path may be designed between the third ultrasonic transducer and the second ultrasonic transducer. According to a further design, the second reference path is designed between the first ultrasonic transducer and the second ultrasonic transducer.

The second reference path may also be designed as part of the first reference path. According to this design, the third ultrasonic transducer is arranged such that it transmits the first reference signal into the medium perpendicular to the direction of flow of the medium through the ultrasonic transducer holding arrangement and the measuring tube wall. The second reference signal corresponds to the reflection of the first reference signal at the transition between the ultrasonic transducer holding arrangement and the measuring tube wall.

According to a further design, there is an attachment arranged on or at the third ultrasonic transducer, wherein the third ultrasonic transducer emits a signal into the attachment at least temporarily and captures the reflection signal. The attachment includes the material of the ultrasonic transducer holding arrangement.

It is particularly preferred that a reflection element for reflecting the second reference signal is designed in the ultrasonic transducer holding arrangement. For example, the reflection element can be designed as a groove in the ultrasonic transducer holding arrangement. According to a further design, the reflection element is designed as a material insert, wherein the material insert comprises a different material than the ultrasonic transducer holding arrangement.

According to a further design, the ultrasonic transducers are arranged on the at least one ultrasonic transducer holding arrangement in a fixed manner, i.e., not displaceable, when viewed in the flow direction of the medium. By taking into account the variation in sound velocities and the resulting change in the measurement path as well as the change in the delay time, it is not necessary to realign or recalibrate the ultrasonic transducers when the process conditions change.

According to one design, the ultrasonic transducer holder arrangement comprises exactly one ultrasonic transducer holder on which the first, second, and third ultrasonic transducers are arranged. In particular, the ultrasonic transducer holder arrangement has at least two wedge-shaped areas, wherein the first ultrasonic transducer and the second ultrasonic transducer are each arranged on the slope of a wedge-shaped area, so that the ultrasonic transducers emit the measurement signal at an angle in the direction of the medium or the measuring tube.

According to a further design, the ultrasonic transducer holder arrangement comprises at least two ultrasonic transducer holders, wherein the at least two ultrasonic transducer holders are designed as wedges in at least some areas, wherein the first ultrasonic transducer is arranged on a first ultrasonic transducer holder and wherein the second ultrasonic transducer is arranged on a second ultrasonic transducer holder. Preferably, the third ultrasonic transducer according to this design is arranged on the first ultrasonic transducer holder or on the second ultrasonic transducer holder.

According to a further design, the ultrasonic transducer holder arrangement has three ultrasonic transducer holders, wherein the first ultrasonic transducer is arranged on the first ultrasonic transducer holder, wherein the second ultrasonic transducer is arranged on the second ultrasonic transducer holder, and wherein the third ultrasonic transducer is arranged on the third ultrasonic transducer holder.

According to a further design, the ultrasonic flowmeter has at most three ultrasonic transducers or at most four ultrasonic transducers. The determination of the current delay time can therefore be performed particularly efficiently with a particularly simple design.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of an ultrasonic flowmeter according to the invention,

FIG. 2 is an example of an ultrasonic flowmeter,

FIG. 3 is an example of an ultrasonic flowmeter,

FIG. 4 is an example of an ultrasonic flowmeter,

FIG. 5 is an example of an ultrasonic flowmeter,

FIG. 6 is an example of an ultrasonic flowmeter,

FIG. 7 is an example of an ultrasonic flowmeter,

FIG. 8 is an example of a method according to the invention,

FIG. 9 is a comparison between the traditional determination of the flow velocity v and the determination of the flow velocity according to the method according to the invention, and

FIG. 10 is an example of a method according to the invention.

### DETAILED DESCRIPTION

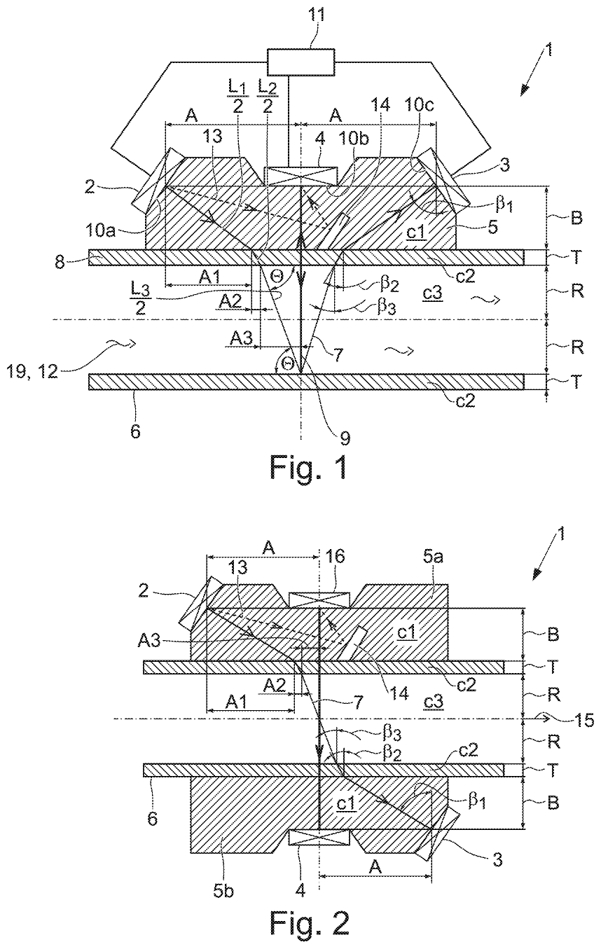

FIG. 1 shows an example of an ultrasonic flowmeter 1. The ultrasonic flowmeter 1 has a first ultrasonic transducer 2 and a second ultrasonic transducer 3, which are arranged on an ultrasonic transducer holder arrangement 5. In the example shown, the ultrasonic transducer holder arrangement 5 comprises an ultrasonic transducer holder, wherein the ultrasonic transducer holder has two wedge-shaped regions and wherein the first ultrasonic transducer 2 and the second ultrasonic transducer 3 are each arranged on the slope of a wedge.

The ultrasonic transducer holding arrangement 5 is arranged on a measuring tube 6, wherein, during operation, a medium 12 flows through the measuring tube. The first and second ultrasonic transducers 2, 3 are arranged on the ultrasonic transducer holder arrangement 5 in such a way that they span a symmetrical V-shaped measuring path 7 between them through the ultrasonic transducer holder arrangement 5, the measuring tube wall 8, and the medium present in the measuring tube 6.

For clarity, the lengths A₁, A₂, and As are shown in the first half of the measuring path, and the angles β₁, β₂, and β₃ are shown in the second half of the measuring path. Due to the symmetrical design, the lengths A₁ to As are also present in the second half of the measuring path, and the angles β₁, β₂, and β₃ are also present in the first half of the measuring path. The measuring angle θ, which is relevant for determining the flow velocity, is also shown.

In addition, a third ultrasonic transducer 4 is provided, wherein the third ultrasonic transducer 4 is also arranged on the ultrasonic transducer holding arrangement 5, wherein the third ultrasonic transducer 4 is arranged between the first ultrasonic transducer 2 and the second ultrasonic transducer 3. Furthermore, the third ultrasonic transducer 4 is arranged on the ultrasonic transducer holding arrangement 5 in such a way that it defines a first reference path 9 which runs perpendicular to the flow direction 19 of the medium 12 through the ultrasonic transducer holding arrangement 5, the measuring tube wall 8 and the medium. In the example shown, the radiating elements 10a, 10b, 10c of the first ultrasonic transducer 2, the second ultrasonic transducer 3, and the third ultrasonic transducer 4 have the same distance B from the measuring tube 6.

Furthermore, the ultrasonic flowmeter 1 has a control and evaluation unit 11 for controlling the ultrasonic transducers 2, 3, 4 and for evaluating the signals captured by the ultrasonic transducers 2, 3, 4.

To determine the flow velocity v of the medium, the transit time of a first measuring signal, which propagates between the first ultrasonic transducer 2 and the second ultrasonic transducer 3 along the measuring path 7 in the direction of flow 19, and the transit time of a second measuring signal, which propagates between the second ultrasonic transducer 3 and the first ultrasonic transducer 2 in the opposite direction to the flow direction 19, are measured. The flow velocity v is determined from the difference in transit time.

However, only the part of the measurement signal that passes through the medium 12 carries information about the flow velocity v of the medium 12. When determining the transit time of the measurement signal, the transit time during which the measurement signal passes through the ultrasonic transducer holder arrangement 5 and the measuring tube wall 8 is subtracted from the total transit time as the delay time t_{d}.

In this case, the delay time ta is not constant when process conditions vary, for example when the medium temperature or the ambient temperature varies.

The arrangement shown allows the current delay time ta of the measuring arrangement to be determined in an advantageous manner, given the design constraints.

For this purpose, a system of equations with three equations and three unknown parameters is set up, wherein each unknown parameter determines the course of the measuring path 7 in one of the materials of the ultrasonic transducer holder arrangement 5, the measuring tube wall 8 and the medium 12.

The first equation determines the total transit time tₜₒₜₐₗ of a measurement signal propagating between the first ultrasonic transducer 2 and the second ultrasonic transducer 3 along the measurement path 7. The following applies to this transit time:

$${t}_{v} = \frac{2 \cdot \sqrt{{A}_{1}^{2} + {B}^{2}}}{{c}_{1}} + \frac{2 \cdot {A}_{1} \cdot ( {A}_{2}^{2} + {T}^{2} )}{{c}_{1} \cdot {A}_{2} \cdot \sqrt{{A}_{1}^{2} + {B}^{2}}} + \frac{2 \cdot {A}_{1} \cdot ( {A}_{3}^{2} + 4 \cdot {R}^{2} )}{{c}_{1} \cdot {A}_{3} \cdot \sqrt{( {A}_{1}^{2} + {B}^{2} )}} \qquad ( 1 )$$

Here, A₁ is the range in the axial direction in which the measuring signal travels through the ultrasonic transducer holder arrangement 5, A₂ is the range in the axial direction in which the measuring signal travels through the measuring tube wall 8, and A₃ is the range in the axial direction in which the measuring signal travels through the medium 12.

B, R, and T are design parameters: B corresponds to the distance between the radiating elements 10a, 10b, 10c of the ultrasonic transducers 2, 3, 4 and the measuring tube 6. In the present example, this is identical for all three ultrasonic transducers 2, 3, 4. R is the inner radius of the measuring tube 6 and T is the thickness of the measuring tube wall 8. These parameters are known in the above equation. For example, they can be obtained by measurement or estimation or by given specifications of the measuring device.

Furthermore, c₁ is the sound velocity of the ultrasonic transducer holder arrangement 5. This sound velocity is also known. In the example shown, the sound velocity c₁ can be measured. For this purpose, a second reference path 13 is provided between the first ultrasonic transducer 2 and the third ultrasonic transducer 4, which runs within the ultrasonic transducer holder arrangement 5, wherein a second reference signal emitted by the first ultrasonic transducer 2 is reflected at a reflection element 14, which is designed as a groove in the example shown, and is received by the third ultrasonic transducer 4.

The individual summands of equation (1) denote the transit times through the individual materials. The first summand corresponds to the transit time through the ultrasonic transducer holder arrangement 5, the second summand corresponds to the transit time through the measuring tube wall 8, and the third summand corresponds to the transit time through the medium.

Due to Snell's law of refraction at the individual material transitions, the individual summands are related to each other. In detail, this relationship and the assumption that the course of the measuring path 7 in each material corresponds to the hypotenuse of a right-angled triangle allow the sound velocities c₂ of the measuring tube wall 8 and the sound velocity c₃ of the medium 12 to be expressed as follows:

$${c}_{2} = \frac{{c}_{1} \cdot {A}_{2} \cdot \sqrt{( {A}_{1}^{2} + {B}^{2} )}}{{A}_{1} \cdot \sqrt{( {A}_{2}^{2} + {T}^{2} )}}$$

$$and$$

$${c}_{3} = \frac{{c}_{1} \cdot {A}_{3} \cdot \sqrt{( {A}_{1}^{2} + {B}^{2} )}}{{A}_{1} \cdot \sqrt{( {A}_{3}^{2} + 4 \cdot {R}^{2} )}}$$

The second equation describes the total transit time of a reference signal emitted by the third ultrasonic transducer 4 and propagating along the first reference path 9 perpendicular to the direction of flow 12 through the ultrasonic transducer holder arrangement 5, the measuring tube wall 8, and the medium 12.

The following applies to this transit time, wherein the sound velocities c₂ and Cs have also been replaced by the relationships described above:

$${t}_{⊥} = \frac{2 \cdot B}{{c}_{1}} + \frac{2 \cdot T \cdot {A}_{1} \sqrt{( {A}_{2}^{2} + {T}^{2} )}}{{c}_{1} \cdot {A}_{2} \cdot \sqrt{( {A}_{1}^{2} + {B}^{2} )}} + \frac{4 \cdot R \cdot {A}_{1} \cdot \sqrt{( {A}_{3}^{2} + 4 \cdot {R}^{2} )}}{{c}_{1} \cdot {A}_{3} \sqrt{( {A}_{1}^{2} + {B}^{2} )}} \qquad ( 2 )$$

The third equation describes a geometric relationship between the half distance A of the first ultrasonic transducer 2 and the second ultrasonic transducer 3 and the three parameters A₁, A₂, and A₃, wherein A₁ corresponds to the proportion of the measuring path 7 in the ultrasonic transducer holder arrangement in the direction of connection of the first ultrasonic transducer 2 and the second ultrasonic transducer 3, wherein A₂ corresponds to the proportion of the measuring path 7 in the measuring tube wall 8 in the direction of connection between the first ultrasonic transducer 2 and the second ultrasonic transducer 3, and wherein A₃ corresponds to the proportion of the measuring path 7 in the medium 12 in the direction of connection between the first ultrasonic transducer 2 and the second ultrasonic transducer 3.

$${A}_{3} = A - {A}_{1} - {A}_{2} \qquad ( 3 )$$

In total, the three equations thus have three unknown parameters, namely A₁, A₂, and A₃.

This system of equations can be solved numerically, for example.

To determine the solution, boundary conditions apply to the parameters A₁ and A₂, which result from the generally possible range of the angle β₁ of the measuring signal to the perpendicular to the measuring tube. If c₁<c₂, the angle β₁ max is limited by the critical angle, after which there is no longer any transmission according to Snell's law of refraction.

If the expected range of values for the sound velocity of the medium c₃ is known, the boundary conditions, in particular the minimum angle β_{1 min} and the maximum angle β_{1 max}, can be determined as follows with the aid of an estimated sound velocity c₂ of the measuring tube:

The following applies:

$${β}_{crit 1} = a sin ( \frac{{c}_{1}}{{c}_{2 estimated}} ) \to {β}_{1 max} = {β}_{crit 1} ( if {c}_{1} < {c}_{2 estimated} )$$

This results in the following for A₁:

$${A}_{1 min} = B \cdot tan ( {β}_{1 min} ) \cdot ( 1 - \frac{ε}{100} )$$

$${A}_{1 max} = B \cdot tan ( {β}_{1 max} ) \cdot ( 1 + \frac{ε}{100} )$$

$${A}_{2 min} = a sin ( {c}_{2 estimated} \cdot sin ( \frac{{β}_{1 min}}{{c}_{1}} ) )$$

$${β}_{2 max} = a sin ( {c}_{2 estimated} \cdot sin ( \frac{{β}_{1 max}}{{c}_{1}} ) )$$

$${β}_{2 max} = {β}_{2 max \cdot possible} ( if {β}_{2 max} \geq {β}_{2 max \cdot possible} )$$

The following boundary conditions result for A₂:

$${A}_{2 min} = T \cdot tan ( {β}_{2 min} ) \cdot ( 1 - \frac{ε}{100} )$$

$${A}_{2 max} = T \cdot tan ( {β}_{2 max} ) \cdot ( 1 + \frac{ε}{100} )$$

In the above equations, ε denotes a possible deviation in the input of the design parameters B, T, or R. denotes the maximum possible angle for β₂.

The values for the sound velocities c₂ and c₃ as well as the path lengths L₁, L₂ and L₃ can then be determined from the values for A₁, A₂ and A₃, wherein L₁ is the path length through the ultrasonic transducer holder arrangement 5, L₂ is the path length through the measuring tube wall 8 and L₃ is the path length through the medium.

The following applies to the path lengths:

$${L}_{1} = 2 \cdot \sqrt{( {A}_{1}^{2} + {B}^{2} )}$$

$${L}_{2} = 2 \cdot \sqrt{( {A}_{2}^{2} + {T}^{2} )}$$

$$and$$

$${L}_{3} = 2 \cdot \sqrt{( {A}_{3}^{2} + 4 \cdot {R}^{2} )}$$

Based on knowledge of the path lengths L₁ to L₃ and the sound velocities c₁ to c₃, the transit time through the ultrasonic transducer holder arrangement 5 and the measuring tube wall 8 can be determined and, in this respect, the current delay time t_{d}.

This allows the current delay time ta to be taken into account when determining the flow velocity according to the following relationship, thereby reducing the overall error in determining the flow velocity.

$$v = \frac{{L}_{3}}{2 \cdot cos ( θ )} \cdot \frac{{t}_{up} - {t}_{down}}{( {t}_{up} - {t}_{d} ) \cdot ( {t}_{down} - {t}_{d} )}$$

FIG. 2 shows another example of an ultrasonic flowmeter 1 arranged on a measuring tube 6. An ultrasonic transducer holder arrangement 5 is arranged on the measuring tube 6, wherein the ultrasonic transducer holder arrangement 5 has two ultrasonic transducer holders 5a, 5b in the example shown. In the example shown, a first ultrasonic transducer holder 5a is arranged above the measuring tube longitudinal axis 15, and a second ultrasonic transducer holder 5b is arranged below the measuring tube longitudinal axis 15.

The ultrasonic transducer holder 5a arranged above the measuring tube longitudinal axis 15 and the ultrasonic transducer holder 5b arranged below the measuring tube longitudinal axis 15 each have an inclined surface. The first ultrasonic transducer 2 is arranged on the inclined surface of the first ultrasonic transducer holder 5a. The second ultrasonic transducer 3 is arranged on the inclined surface of the second ultrasonic transducer holder 5b. The measuring path 7 is spanned between the first ultrasonic transducer 2 and the second ultrasonic transducer 3, through which a measuring signal passes that propagates between the first ultrasonic transducer 2 and the second ultrasonic transducer 3. In the example shown, the measuring path 7 does not exhibit any reflection at the measuring tube wall 8. Rather, the measuring path 7 is essentially Z-shaped.

In addition, a fourth ultrasonic transducer 16 is arranged on the ultrasonic transducer holder 5a located above the measuring tube longitudinal axis 15, which is emitting a signal perpendicular to the measuring tube longitudinal axis 15 during operation. The third ultrasonic transducer 4 is arranged on the second ultrasonic transducer holder. The third ultrasonic transducer 4 and the fourth ultrasonic transducer 16 span a first reference path 9 between them.

In addition, a reflection element 14 in the form of a groove is arranged in the first ultrasonic transducer holder 5a. A second reference path 13 is designed between the first ultrasonic transducer 2 and the fourth ultrasonic transducer 16, wherein the reflection element 14 reflects a second reference signal emitted by the first ultrasonic transducer 2 onto the fourth ultrasonic transducer 16.

For this example, the three relevant equations are:

$${t}_{/} = \frac{2 \cdot \sqrt{{A}_{1}^{2} + {B}^{2}}}{{c}_{1}} + \frac{2 \cdot {A}_{1} \cdot ( {A}_{2}^{2} + {T}^{2} )}{{c}_{1} \cdot {A}_{2} \cdot \sqrt{{A}_{1}^{2} + {B}^{2}}} + \frac{2 \cdot {A}_{1} \cdot ( {A}_{3}^{2} + {R}^{2} )}{{c}_{1} \cdot {A}_{3} \cdot \sqrt{( {A}_{1}^{2} + {B}^{2} )}} \qquad ( 1 )$$

$${t}_{⊥} = \frac{2 \cdot B}{{c}_{1}} + \frac{2 \cdot T \cdot {A}_{1} \sqrt{( {A}_{2}^{2} + {T}^{2} )}}{{c}_{1} \cdot {A}_{2} \cdot \sqrt{( {A}_{1}^{2} + {B}^{2} )}} + \frac{2 \cdot R \cdot {A}_{1} \cdot \sqrt{( {A}_{3}^{2} + {R}^{2} )}}{{c}_{1} \cdot {A}_{3} \sqrt{( {A}_{1}^{2} + {B}^{2} )}} \qquad ( 2 )$$

$${A}_{3} = A - {A}_{1} + {A}_{2} \qquad ( 3 )$$

As explained above, the parameters B, T, R, A, and c₁ are assumed to be known. In particular, the sound velocity c₁ can be measured using the second reference signal.

The parameters A₁, A₂, and A₃ can be determined by solving the system of equations.

The parameters A₁, A₂, and As can then be used to determine the sound velocities c₂ and c₃ as well as the path lengths L₁, L₂, and L₃ as follows:

$${L}_{1} = 2 \cdot \sqrt{( {A}_{1}^{2} + {B}^{2} )}$$

$${L}_{2} = 2 \cdot \sqrt{( {A}_{2}^{2} + {T}^{2} )}$$

$$and$$

$${L}_{3} = 2 \cdot \sqrt{( {A}_{3}^{2} + {R}^{2} )}$$

The current delay time ta and, from this, the flow velocity v of the medium can be determined with particular accuracy from the path lengths determined.

Alternatively, instead of the lengths A₁, A₂, and A₃, an angle of a right-angled triangle in a material can also serve as an unknown parameter. In this case, the three equations are:

$${t}_{/} = \frac{2 \cdot B}{{c}_{1} \cdot cos ( {β}_{1} )} + \frac{4 \cdot T \cdot cos ( \frac{π}{2} - {β}_{1} )}{{c}_{1} \cdot cos ( 2 \cdot {β}_{2} - \frac{π}{2} )} + \frac{4 \cdot R \cdot cos ( \frac{π}{2} - {β}_{1} )}{{c}_{1} \cdot cos ( 2 \cdot {β}_{3} - \frac{π}{2} )} \qquad ( 1 )$$

$${t}_{⊥} = \frac{2 \cdot B}{{c}_{1}} + \frac{2 \cdot T \cdot cos ( \frac{π}{2} - {β}_{1} )}{{c}_{1} \cdot cos ( \frac{π}{2} - {β}_{2} )} + \frac{2 \cdot R \cdot cos ( \frac{π}{2} - {β}_{1} )}{{c}_{1} \cdot cos ( \frac{π}{2} - {β}_{3} )} \qquad ( 2 )$$

$$A = B \cdot tan ( {β}_{1} ) + T \cdot tan ( {β}_{2} ) + R \cdot tan ( {β}_{3} ) \qquad ( 3 )$$

In this case, the angles β₁, β₂, and β₃ are the unknown parameters to be determined.

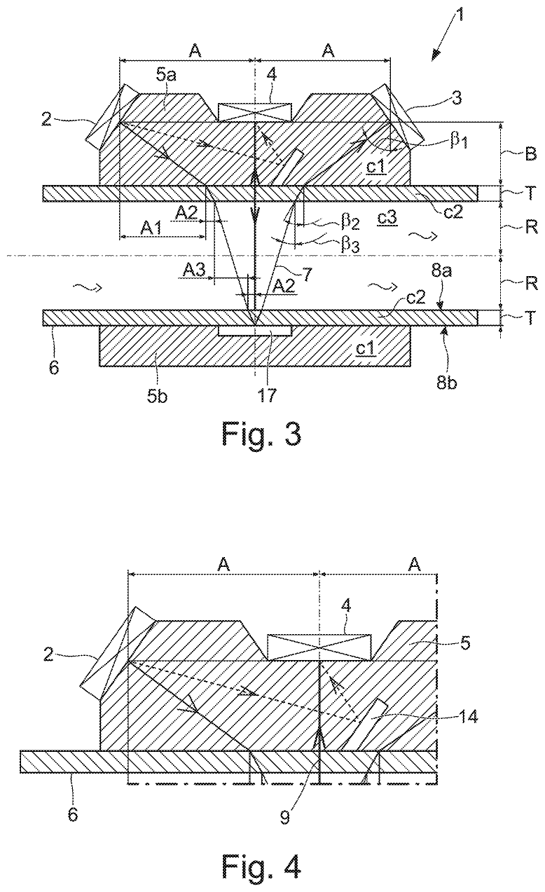

FIG. 3 shows another example of an ultrasonic flowmeter 1, wherein an ultrasonic transducer holder arrangement 5 is arranged on a measuring tube 6 and wherein a first ultrasonic transducer 2 and a second ultrasonic transducer 3 and a third ultrasonic transducer 4 are arranged on the ultrasonic transducer holder arrangement 5. The first ultrasonic transducer 2 and the second ultrasonic transducer 3 span a V-shaped measuring path 7 between them.

In contrast to the first example, the measuring signal in the measuring tube 6 is not reflected at the inner measuring tube wall 8a, but at the outer measuring tube wall 8b. For this purpose, a groove 17 is arranged on the ultrasonic transducer holder 5b located below the measuring tube longitudinal axis to implement a material transition. The ultrasonic transducer holder 5b is optional in the example shown; it may therefore also be omitted in some designs. However, an ultrasonic transducer holder 5b arranged opposite the first ultrasonic transducer holder 5a improves the mechanical stability of the measuring arrangement, especially when installing the flowmeter on plastic measuring tubes with small diameters.

The three relevant equations of the equation system for the example shown are:

$${t}_{v} = \frac{2 \cdot \sqrt{{A}_{1}^{2} + {B}^{2}}}{{c}_{1}} + \frac{4 \cdot {A}_{1} \cdot ( {A}_{2}^{2} + {T}^{2} )}{{c}_{1} \cdot {A}_{2} \cdot \sqrt{{A}_{1}^{2} + {B}^{2}}} + \frac{2 \cdot {A}_{1} \cdot ( {A}_{3}^{2} + 4 \cdot {R}^{2} )}{{c}_{1} \cdot {A}_{3} \cdot \sqrt{( {A}_{1}^{2} + {B}^{2} )}} \qquad ( 1 )$$

$${t}_{⊥} = \frac{2 \cdot B}{{c}_{1}} + \frac{4 \cdot T \cdot {A}_{1} \sqrt{( {A}_{2}^{2} + {T}^{2} )}}{{c}_{1} \cdot {A}_{2} \cdot \sqrt{( {A}_{1}^{2} + {B}^{2} )}} + \frac{4 \cdot R \cdot {A}_{1} \sqrt{( {A}_{3}^{2} + 4 \cdot {R}^{2} )}}{{c}_{1} \cdot {A}_{3} \sqrt{( {A}_{1}^{2} + {B}^{2} )}} \qquad ( 2 )$$

$${A}_{3} = A - {A}_{1} - ( 2 \cdot {A}_{2} ) \qquad ( 3 )$$

As explained above, the parameters B, T, R, A, and c₁ are assumed to be known. In particular, the sound velocity c₁ can be measured using the second reference signal.

The parameters A₁, A₂, and A₃ can be determined by solving the system of equations.

The parameters A₁, A₂, and A₃ can then be used to determine the sound velocities c₂ and c₃ as well as the path lengths L₁, L₂, and L₃ as follows:

$${L}_{1} = 2 \cdot \sqrt{( {A}_{1}^{2} + {B}^{2} )}$$

$${L}_{2} = 4 \cdot \sqrt{( {A}_{2}^{2} + {T}^{2} )}$$

$$and$$

$${L}_{3} = 2 \cdot \sqrt{( {A}_{3}^{2} + 4 \cdot {R}^{2} )}$$

The current delay time ta and, from this, the flow velocity of the medium can be determined with particular accuracy from the determined path lengths.

The following three FIGS. 4, 5, and 6 show sections of an ultrasonic flowmeter 1, detailing possible designs of a second reference path 9.

FIG. 4 shows an example wherein the second reference path 9 is arranged between the first ultrasonic transducer 2 and the third ultrasonic transducer 4. For this purpose, a reflection element 14 in the form of a groove is designed in the ultrasonic transducer holder arrangement 5.

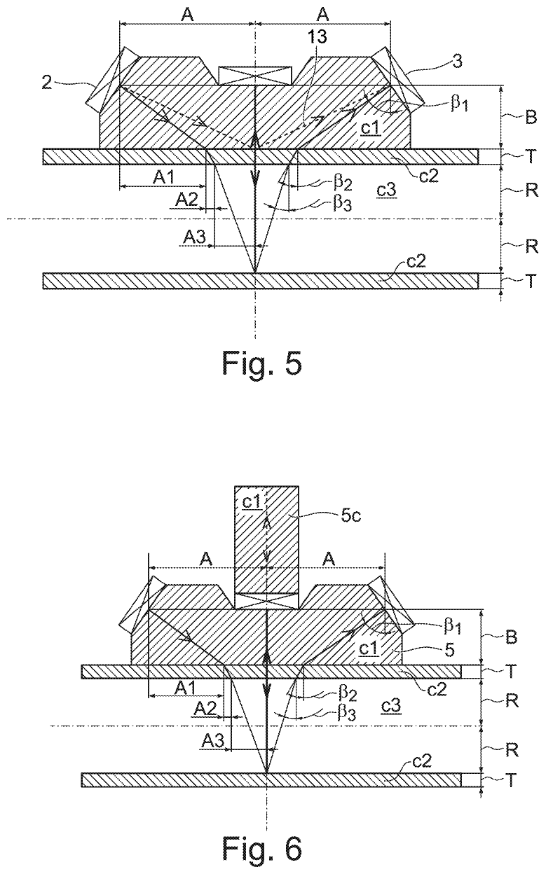

FIG. 5 shows an example in which the second reference path 9 is designed between the first ultrasonic transducer 2 and the second ultrasonic transducer 3.

FIG. 6 shows an example in which an attachment 5c made of the material of the ultrasonic transducer holder arrangement 5 is arranged on the third ultrasonic transducer 4. A second reference signal is transmitted from the third ultrasonic transducer 4 to the attachment 5c and received again after reflection at the edge of the attachment 5c.

FIG. 7 shows another example of an ultrasonic flowmeter 1, wherein the ultrasonic transducer holder arrangement 5 has two ultrasonic transducer holders 5a, 5b, wherein a first ultrasonic transducer 2 and a third ultrasonic transducer 4 are arranged on the first ultrasonic transducer holder 5a, wherein a second ultrasonic transducer 3 is arranged on the second ultrasonic transducer holder 5b. A separator 18 is arranged between the first ultrasonic transducer 2 and the second ultrasonic transducer 3. In the unfixed state, the distance between the first ultrasonic transducer holder 5a and the second ultrasonic transducer holder 5b can be adjusted during a calibration process prior to commissioning. It is also conceivable that different separators 18 are suitable for different applications. Optionally, the separator 18 can also be removed again after installation. Installing the ultrasonic transducers 2, 3 with the aid of the separator ensures that the ultrasonic transducers 2, 3 are spaced 2A apart.

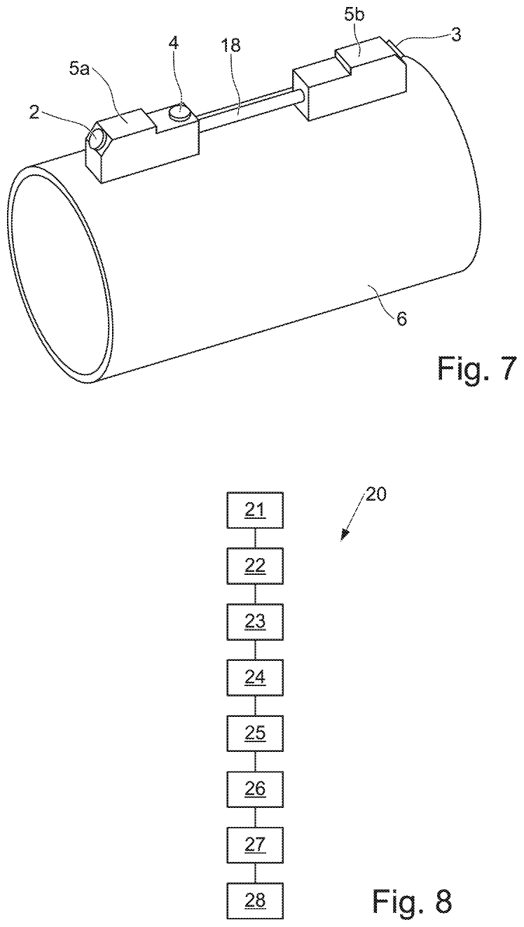

FIG. 8 shows an example of a method 20 for operating an ultrasonic flowmeter 1, where the ultrasonic flowmeter 1 is designed as shown in FIG. 1.

The method 20 comprises the following steps: emitting 21 the measuring signal by the first ultrasonic transducer 2 or the second ultrasonic transducer 3, wherein the measuring signal propagates along the measurement path 7; receiving 22 the measuring signal by the second ultrasonic transducer 3 or the first ultrasonic transducer 2 and determining the transit time tₜₒₜₐₗ, wherein tₜₒₜₐₗ corresponds to the total transit time of the measuring signal between the first ultrasonic transducer 2 and the second ultrasonic transducer 3; emitting 23 the reference signal by the third ultrasonic transducer 4 or a further ultrasonic transducer; receiving 24 the reference signal by the third ultrasonic transducer 4 and determining the transit time t_{ref}, wherein t_{ref} corresponds to the transit time of the reference signal between the ultrasonic transducer that emits the reference signal and the third ultrasonic transducer 4; and creating 25 a system of equations with three equations based on the known design parameters A, B, R, and T and on the sound velocity c₁ of the ultrasonic transducer holder arrangement 5, wherein the first equation describes a relationship between the total transit time tₜₒₜₐₗ of the measuring signal and the individual transit times of the measuring signal via the measurement path 7 through the three materials, wherein the second equation describes a relationship between the reference transit time t_{ref} and the individual transit times of the reference signal via the reference path 9 through the three materials, and wherein the third equation describes a geometric relationship between the distance between the first ultrasonic transducer 2 and the second ultrasonic transducer 3 and a respective geometric parameter of the measurement path of the three materials, wherein the system of equations contains at most three unknown parameters, wherein each unknown parameter determines the course of the measuring path in a material, in particular wherein the unknown parameters are geometric parameters, preferably lengths or angles; solving 26 the system of equations and determining the unknown parameters; determining 27 the course L of the measuring path and determining the delay time ta of the measuring signal, wherein the delay time ta corresponds to the transit time of the measuring signal through the ultrasonic transducer holder arrangement and the measuring tube wall; and determining 28 the velocity v of the flowing medium, taking into account the current delay time t_{d}.

The course L of the measuring path 7 is understood to be the geometric description of the measuring path 7. In detail, both the lengths of the measuring path sections L₁, L₂, and L₃ are determined, as are the angles β₁, β₂, and β₃. The measuring angle θ can be determined from the angle β₃. For the V-shaped course of the measuring path shown in FIG. 1, sin (θ)=(4·R)/L₃ applies.

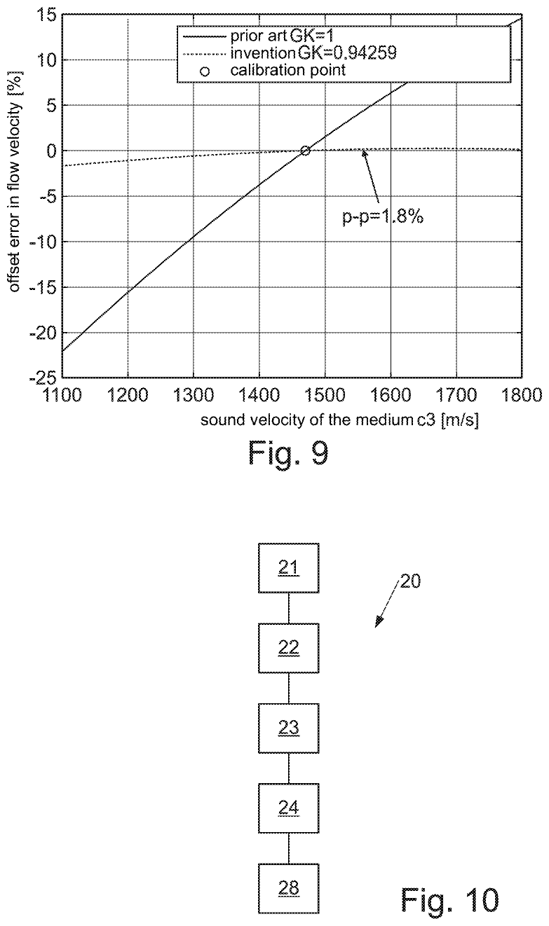

With the method shown, the offset error, which is due to the dependence of the determination of the flow velocity on the sound velocity of the different materials, can be almost completely avoided, especially with small dimensions of the measuring arrangement. This even applies if, as shown in FIG. 9 below, the basic assumptions are subject to a certain degree of inaccuracy.

FIG. 9 shows a comparison between the traditional determination of the flow velocity v of a flowing fluid, in which the change in the delay time when the sound velocity of the medium and the measuring tube wall changes is not taken into account, and a determination of the flow velocity according to the method of the invention. To illustrate the great advantage of the method of the invention, we will now show what happens when the design parameter inputs are somewhat inaccurate, i.e., do not perfectly correspond to reality. The geometric constant (GK) determined by the design parameters is therefore not equal to 1 here. In the example shown, a value of 24.5 mm was entered as the radius of the measuring tube. In reality, however, the radius was 25 mm. In the method known from the prior art, on the other hand, the design parameters were correctly taken into account (GK=1).

At first glance, the illustration shows that when the sound velocity of the medium changes, the error in determining the flow velocity according to the traditional method quickly becomes very large.

In contrast, a change in the sound velocity of the medium can be well compensated for using the method according to the invention. Even if, as shown here, inaccuracies are made in the input of the design parameters, an offset error in the determination of the flow velocity can be almost completely avoided. In the example shown, the peak-to-peak error is at most 1.8% for a change in the sound velocity between 1100 m/s and 1800 m/s.

FIG. 10 shows another example of a method 20 for operating an ultrasonic flowmeter designed according to FIG. 1. In contrast to the explanations in FIG. 1, the flow velocity is not necessarily determined using the described system of equations.

The control and evaluation unit 11 has a trained artificial intelligence that determines the flow velocity v of the medium based on design input parameters, the input of the transit times tₜₒₜₐₗ and t_{ref}, and the sound velocity c₁ of the ultrasonic transducer holder arrangement.

The method comprises the following steps: emitting 21 of the measuring signal by the first ultrasonic transducer 2 or the second ultrasonic transducer 3, wherein the measuring signal propagates along the measurement path 7; receiving 22 the measuring signal by the second ultrasonic transducer 3 or the first ultrasonic transducer 2 and determining the total transit time tₜₒₜₐₗ, wherein tₜₒₜₐₗ corresponds to the total transit time of the measuring signal between the first ultrasonic transducer 2 and the second ultrasonic transducer 3; emitting 23 the first reference signal by the third ultrasonic transducer 4 or a further ultrasonic transducer 16; receiving 24 the first reference signal by the third ultrasonic transducer 4 and determining the reference transit time t_{ref}, wherein t_{ref} corresponds to the transit time of the first reference signal between the ultrasonic transducer 4, 16, which emits the first reference signal, and the third ultrasonic transducer 4; and determining (28) the velocity v of the flowing medium using known design parameters of the measuring arrangement, the measured transit times t_{ref} and tₜₒₜₐₗ, and the sound velocity c₁ of the ultrasonic transducer holder arrangement 5.

This method also has the advantage that, with the help of the measurements of the transit times and the known design parameters as well as the sound velocity c₁ according to the invention, a particularly accurate value of the flow velocity can be determined, since the artificial intelligence develops, through appropriate training, an error correction for the relationship between the flow velocity and varying sound velocities of the medium and/or the measuring tube wall and/or the ultrasonic transducer holder arrangement.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of operating an ultrasonic flowmeter, the method comprising:
providing the ultrasonic flowmeter that comprises:
at least one pair of ultrasonic transducers comprising a first ultrasonic transducer and a second ultrasonic transducer;
at least one third ultrasonic transducer;
at least one ultrasonic transducer holder arrangement and a control and evaluation unit,
wherein the ultrasonic transducer holder arrangement has at least one ultrasonic transducer holder,
wherein the ultrasonic transducer holder arrangement is arranged on a measuring tube, the measuring tube having a measuring tube wall,
wherein a medium is present in the measuring tube such that the medium is adapted to flow through the measuring tube,
wherein the first and second ultrasonic transducers are arranged on the ultrasonic transducer holder arrangement,
wherein the first ultrasonic transducer and the second ultrasonic transducer are arranged offset from one another as viewed in a direction of flow of the medium such that they span between them a measuring path that passes through the ultrasonic transducer holder arrangement, the measuring tube wall and the medium so that a measuring signal emitted by the first ultrasonic transducer is received by the second ultrasonic transducer and vice versa, the measuring signal adapted to pass through three materials, namely the ultrasonic transducer holder arrangement, the measuring tube wall and the medium, and
wherein the third ultrasonic transducer is arranged on the ultrasonic transducer holder arrangement such that it defines at least a first reference path that passes through the ultrasonic transducer holder arrangement, the measuring tube wall and the medium,
wherein the third ultrasonic transducer is designed and arranged such that it receives and optionally also transmits a reference signal which propagates along the first reference path, and
wherein the control and evaluation unit is designed to control the ultrasonic transducers and to evaluate the signals received from the ultrasonic transducers;
emitting the measuring signal by the first ultrasonic transducer or the second ultrasonic transducer, wherein the measuring signal propagates along the measuring path;
receiving the measuring signal by the second ultrasonic transducer or the first ultrasonic transducer and determining a total transit time tₜₒₜₐₗ, wherein tₜₒₜₐₗ corresponds to the total transit time of the measuring signal between the first ultrasonic transducer and the second ultrasonic transducer;
emitting the reference signal by the third ultrasonic transducer or another ultrasonic transducer;
receiving the first reference signal by the third ultrasonic transducer and determining the reference transit time t_{ref}, wherein t_{ref} corresponds to the transit time of the reference signal between the ultrasonic transducer transmitting the reference signal and the third ultrasonic transducer; and
determining a velocity of the flowing medium using known constructive parameters of the measuring arrangement, the measured transit times t_{ref} and tₜₒₜₐₗ and the sound velocity of the ultrasonic transducer holder.

2. The method according to claim 1, wherein the step for determining the velocity of the flowing medium comprises:
determining three unknown parameters using known constructive parameters of the measuring arrangement, the measured transit times t_{ref} and tₜₒₜₐₗ and the sound velocity of the ultrasonic transducer holder arrangement, wherein in each case one unknown parameter determines the course of the measuring path in one of the three materials, or wherein the unknown parameters are geometric parameters, lengths or angles;
determining the course of the measuring path in the ultrasonic transducer holder arrangement in the measuring tube wall and in the medium and determining a delay time of the measuring signal, wherein the delay time corresponds to the transit time of the measuring signal through the ultrasonic transducer holder arrangement and the measuring tube wall; and
determining the velocity of the flowing medium, taking into account the current delay time.

3. The method according to claim 1, wherein the velocity of the flowing medium is determined using trained artificial intelligence or a trained artificial neural network, wherein the artificial intelligence receives as input variables the constructive parameters, the measured transit times t_{ref} and tₜₒₜₐₗ and the sound velocity of the ultrasonic transducer holder arrangement, and wherein the artificial intelligence supplies as output variable at least the velocity of the flowing medium.

4. The method according to claim 2, wherein the step for determining the unknown parameters comprises:
creating a system of equations with three equations, wherein the first equation describes a relationship between the total transit time tₜₒₜₐₗ of the measuring signal and the individual transit times of the measuring signal over the measuring path through the ultrasonic transducer holder arrangement, the measuring tube wall and the medium, taking into account the constructive parameters, wherein the second equation describes a relationship between the reference transit time t_{ref} and the individual transit times of the reference signal over the reference path through the ultrasonic transducer holder arrangement, the measuring tube wall and the medium, taking into account the constructive parameters, and wherein the third equation describes a geometric relationship between the distance between the first ultrasonic transducer and the second ultrasonic transducer and three geometric parameters, wherein one geometric parameter describes the course of the measuring path in the ultrasonic transducer holder arrangement, one geometric parameter describes the course of the measuring path in the measuring tube wall and wherein one geometric parameter describes the course of the measuring path in the medium, wherein the system of equations contains at most three unknown parameters, and wherein one unknown parameter determines the course of the measurement path in one of the three materials, in particular wherein the unknown parameters are geometric parameters, lengths or angles; and
solving the system of equations and determining the unknown parameters.

5. The method according to claim 1, wherein the first ultrasonic transducer and the second ultrasonic transducer are arranged at a distance from each other and the third equation describes the relationship between the half distance between the ultrasonic transducers and the three parameters A₁, A₂ and A₃, wherein A₁ corresponds to the proportion of the measuring path in the ultrasonic transducer holder arrangement in the connecting direction of the first ultrasonic transducer and the second ultrasonic transducer, wherein A₂ corresponds to the proportion of the measuring path in the measuring tube wall in the connecting direction of the first ultrasonic transducer and the second ultrasonic transducer, and wherein A₃ corresponds to the proportion of the measuring path in the medium in the connecting direction of the first ultrasonic transducer and the second ultrasonic transducer.

6. The method according to claim 1, wherein the first equation and/or the second equation of the system of equations take into account, as constructive parameters, a distance B₁ of the radiating element of the first ultrasonic transducer from the measuring tube and/or a distance B₂ of the second ultrasonic transducer from the measuring tube and/or a distance B₃ of the radiating element of the third ultrasonic transducer from the measuring tube and/or a thickness T of the measuring tube wall and/or the inner radius R of the measuring tube, in particular wherein the values of these parameters are known.

7. The method according to claim 1, wherein the measurement path L is divided into measurement path sections L₁, L₂, L₃, wherein the measurement path section L₁ runs in the ultrasonic transducer holder arrangement, wherein the measurement path section L₂ runs in the measurement tube wall and wherein the measurement path section L₃ runs in the medium and wherein each measurement path section L₁, L₂, L₃ comprises at least one hypotenuse of a right triangle.

8. The method according to claim 1, wherein the first reference path passes through the ultrasonic transducer holder arrangement, the measuring tube wall and the medium perpendicular to the direction of flow of the medium, so that no refraction takes place at the material transitions.

9. The method according to claim 1, wherein in the first equation the transit times of the measuring signal along the measuring path through the measuring tube wall and through the medium are expressed in dependence on the sound velocity c₁ of the ultrasonic transducer holder arrangement and/or wherein in the second equation the transit times of the measuring signal along the measuring path through the measuring tube wall and through the medium are expressed in dependence on the sound velocity c₁ of the ultrasonic transducer holder arrangement.

10. The method according to claim 1, wherein the total path length L of the measuring path and/or the length of the individual measuring path sections L₁, L₂, L₃ and/or the coupling angle β₂ of the measuring signal into the measuring tube wall and/or the coupling angle β₃ of the measuring signal into the medium and/or the sound velocity c₂ of the measuring tube wall and/or the sound velocity c₃ of the medium are determined by solving the system of equations.

11. The method according to claim 1, wherein a second reference path is provided, wherein the second reference path extends only within the material of the ultrasonic transducer holder arrangement, and wherein the sound velocity c₁ of the ultrasonic transducer holder arrangement is determined by a transit time measurement of a second reference signal propagating along the second reference path.

12. The method according to claim 1, wherein the system of equations is solved numerically, taking into account boundary conditions of the unknown parameters to be determined.

13. The method according to claim 1, wherein the distance B₃ of the radiating element of the third ultrasonic transducer to the measuring tube and/or the thickness T of the measuring tube wall and/or the inner radius R of the measuring tube are measured by a transit time measurement of a reflection of the first reference signal.

14. An ultrasonic flowmeter comprising:
at least one pair of ultrasonic transducers comprising a first ultrasonic transducer and a second ultrasonic transducer;
at least one third ultrasonic transducer;
at least one ultrasonic transducer holder arrangement having at least one ultrasonic transducer holder, the at least one ultrasonic transducer holder arrangement being arranged on a measuring tube during operation, the measuring tube having a measuring tube wall, wherein a medium being provided in the measuring tube during operation such that the medium is adapted to flow through the measuring tube during operation, wherein the first and second ultrasonic transducers are arranged on the ultrasonic transducer holder arrangement,
wherein the first ultrasonic transducer and the second ultrasonic transducer are arranged offset from one another as viewed in the direction of flow of the medium in such a way that they span a measuring path between them which passes through the ultrasonic transducer holder arrangement, the measuring tube wall and the medium so that a measuring signal emitted by the first ultrasonic transducer is received by the second ultrasonic transducer and vice versa,
wherein the measuring signal passes through three materials, namely the ultrasonic transducer holder arrangement, the measuring tube wall and the medium, and
wherein the third ultrasonic transducer is arranged on the ultrasonic transducer holder arrangement such that it defines at least a first reference path which passes through the ultrasonic transducer holder arrangement, the measuring tube wall and the medium,
wherein the third ultrasonic transducer is designed and arranged such that it receives and optionally also transmits a reference signal that propagates along the first reference path,
wherein the control and evaluation unit is designed to control the ultrasonic transducers and to evaluate the signals received from the ultrasonic transducers, and
wherein the control and evaluation unit is designed to carry out the method according to claim 1.

15. The ultrasonic flowmeter according to claim 14, wherein the third ultrasonic transducer is arranged on the ultrasonic transducer holder arrangement in such a way that the first reference path runs perpendicular to the flow direction of the flowing medium.

16. The ultrasonic flowmeter according to claim 14, wherein the ultrasonic transducers are arranged in such a way that a second reference path, via which a second reference signal propagates, is present, wherein the second reference path runs only within the material of the ultrasonic transducer holder arrangement.

17. The ultrasonic flowmeter according to claim 14, wherein a reflection element for reflecting the second reference signal is designed in the ultrasonic transducer holder arrangement.

18. The ultrasonic flowmeter according to claim 14, wherein the ultrasonic transducers are arranged fixedly, i.e. not adjustably, on the at least one ultrasonic transducer holder as viewed in the flow direction of the medium.

19. The ultrasonic flowmeter according to claim 14, wherein the ultrasonic flowmeter has at most three ultrasonic transducers or at most three or four ultrasonic transducers.
